(19) United States
(12) Patent Application Publication
(10) Pub. No.: US 2009/0193215 A1
(43) Pub. Date: Jul. 30, 2009

(54) ERASING AND RESTORING FACTORY SETTINGS IN COMPUTER SYSTEMS

(76) Inventor: Keith A. Rogers, Spring, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 12/020,408

(22) Filed: Jan. 25, 2008

(51) Int. Cl. G06F 12/00

(52) U.S. Cl. 711/166; 711/112; 711/E12.001

(57) ABSTRACT

In one embodiment, a computer system comprising a system restoration control module within which resides a erasure module. In one embodiment, the computer system allows a user to erase personally identified information from a computer system without concern that the information will be subsequently retrieved and restore the computer system to its original factory settings.

### TECHNICAL FIELD

This application relates to electronic computing, and more particularly erasing and restoring factory settings in computer systems.

### BACKGROUND

Currently, a very small percentage of old computer systems are recycled. After some use, computer systems may contain personally identifiable information. One reason for the current lack of computer system recycling is consumers concerns that their personally identifiable information will be retrieved from the recycled computer system.

### BRIEF DESCRIPTION OF THE DRAWINGS

FIG. 1 is a schematic illustration of a computer system comprising a system restoration control module, according to embodiments.

FIG. 2 is a schematic illustration of a system restoration control module, according to embodiments.

FIG. 3 is a flowchart illustrating operations in one embodiment of a system restoration control module with an erasure module.

FIG. 4 is a schematic illustration of a computing environment, according to embodiments.

### DETAILED DESCRIPTION

Described herein are exemplary system and methods for implementing data erasure and factory setting restoration in an electronic device such as, e.g., a computing system. Some of the methods described herein may be embodied as logic instructions on a computer-readable medium. When executed on a processor, the logic instructions cause a general purpose computing device to be programmed as a special-purpose machine that implements the described methods. The processor, when configured by the logic instructions to execute the methods recited herein, constitutes structure for performing the described methods.

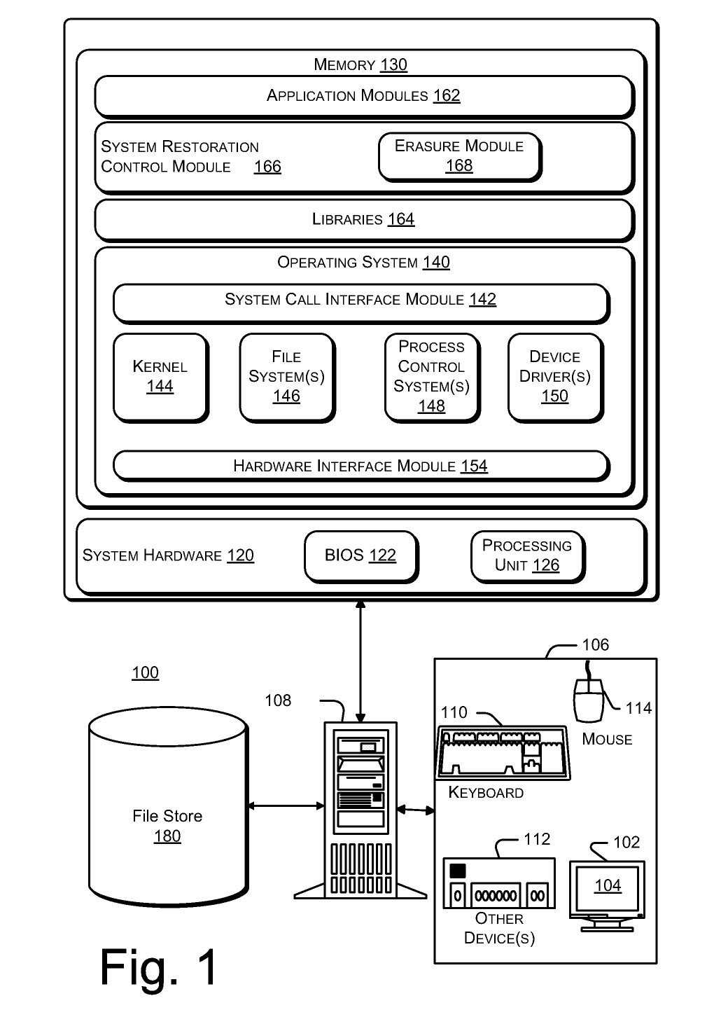

FIG. 1 is a schematic illustration of a computing system 100 adapted to include a system restoration control module including an erasure module, according to some embodiments. In the illustrated embodiment, system 100 may be embodied as a hand-held or stationary device for accessing the Internet, a desktop PCs, notebook computer, personal digital assistant, or any other processing devices.

The computing system 100 includes a computer 108 and one or more accompanying input/output devices 106 including a display 102 having a screen 104, a keyboard 110, other I/I device(s) 112, and a mouse 114. The other device(s) 112 can include a touch screen, a voice-activated input device, a track ball, and any other device that allows the system 100 to receive input from a developer and/or a user. The computer 108 includes system hardware 120 including a processing unit 126, a basic input/output system (BIOS) 122, and random access memory and/or read-only memory 130. A file store 180 is communicatively connected to computer 108. File store 180 may be internal such as, e.g., one or more hard drives, or external such as, e.g., one or more external hard drives, network attached storage, or a separate storage network.

Memory 130 includes an operating system 140 for managing operations of computer 108. In one embodiment, operating system 140 includes a hardware interface module 154 that provides an interface to system hardware 120. In addition, operating system 140 includes a kernel 144, one or more file systems 146 that manage files used in the operation of computer 108 and a process control subsystem 148 that manages processes executing on computer 108. Operating system 140 further includes one or more device drivers 150 and a system call interface module 142 that provides an interface between the operating system 140 and one or more application modules 162 and/or libraries 164. The various device drivers 150 interface with and generally control the hardware installed in the computing system 100.

In operation, one or more application modules 162 and/or libraries 164 executing on computer 108 make calls to the system call interface module 142 to execute one or more commands on the computer's processor. The system call interface module 142 invokes the services of the file systems 146 to manage the files required by the command(s) and the process control subsystem 148 to manage the process required by the command(s). The file system(s) 146 and the process control subsystem 148, in turn, invoke the services of the hardware interface module 154 to interface with the system hardware 120. The operating system kernel 144 can be generally considered as one or more software modules that are responsible for performing many operating system functions.

The particular embodiment of operating system 140 is not critical to the subject matter described herein. Operating system 140 may be embodied as a UNIX operating system or any derivative thereof (e.g., Linux, Solaris, etc.) or as a Windows® brand operating system.

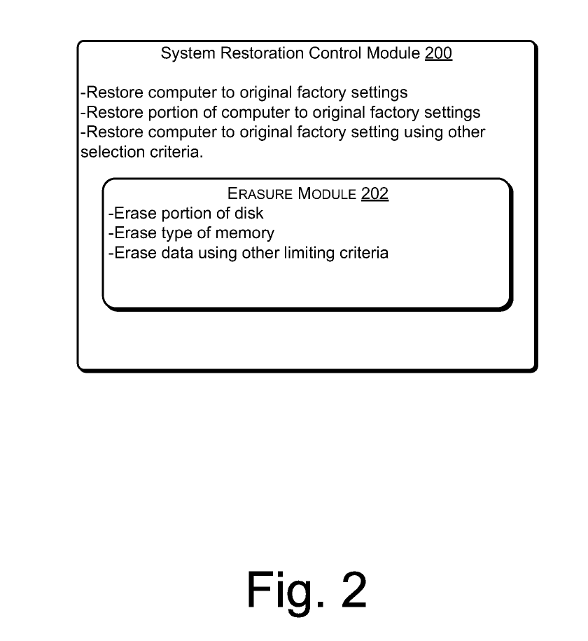

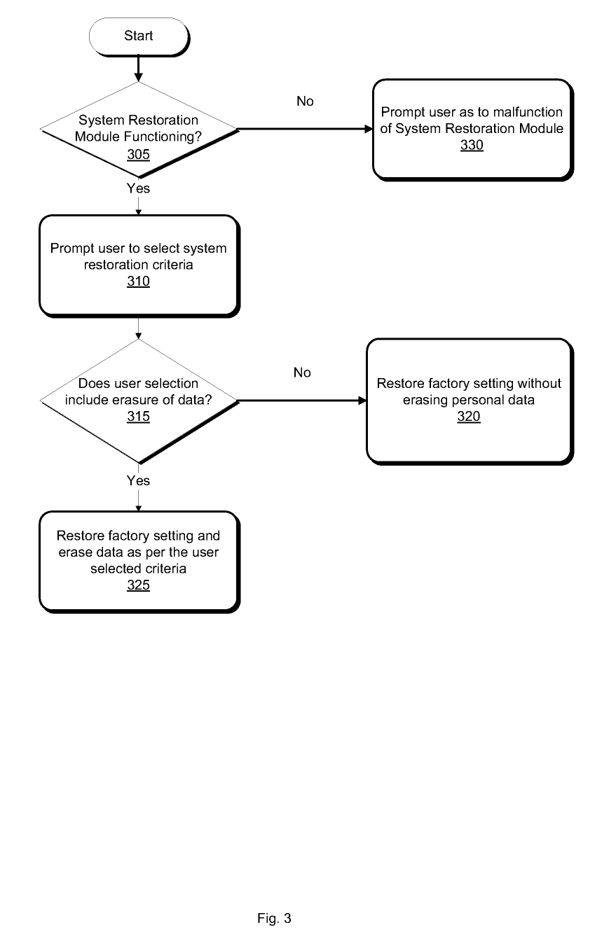

In some embodiments, computer system 100 comprises a system restoration control module 166, which may be embodied as logic instructions recorded in a computer readable medium. In some embodiments, the system restoration control module 166 further comprises, but is not limited to, an erasure module 168. Additional details with respect to the system restoration control module 166 are discussed below and with reference to FIGS. 2 and 3.

FIG. 2 is a schematic illustration of a system restoration control module, according to some embodiments. The system restoration control module may comprise, but is not limited to, components such as an erasure module 202. In some embodiments, an erasure module may erase data on a computing system such that no personal data remains. By way of example and not limitation, to assure no personal data remains, an erasure module may comply with United States Department of Defense Standard 5220.22-M Subsection 8-5-3 which clears magnetic disks, overwrite all locations three (3) times (first time with a character, second time with its complement, and the third time with a random character). In some embodiments, the system restoration control module 200 may provide a user with various options as to the extent to which the user wishes to restore the computer system to its original factory settings.

For example, and not limitation, the user options may include options to; erase only a portion of a user's data (i.e, specified partition only), erase only a specified type of data (i.e. RAM, ROM, NVRAM, etc.), erase data defined by the creation date of the data, erase data defined by the user that created the data, erase data defined by the program in which the data was created or the like.

By way of example, and not limitation, most hard disks are partitioned into a boot partition which holds boot data and a factory image partition which holds the software images as shipped from the factory. The factory image partition is usually compressed. In some embodiments, the erasure module 202 erases the remainder of the hard disk and then uses the factory image partition to restore the computer system to its original factory settings. For the purposes of this invention, erasure of data is defined with reference to United States Department of Defense Standard 5220.22-M, Chapter 8-301. Clearing and Sanitization.

Additionally, and not in limitation of, the system restoration control module 200 may receive an input to restore the factory settings without erasing any personal data stored on the computer system.

FIG. 3 is a flowchart illustrating operations in one embodiment of a system restoration control module, such as the system restoration control module 166 depicted in FIG. 1. Referring to FIG. 3, if, at operation 305, the system restoration module is selected but not functioning, then control passes to operation 340 and the computer system communicates the malfunction to the user. By contrast, if at operation 305 the system restoration module is active and functioning then at operation 310 the system restoration control module 166 prompts the user to select restoration criteria.

Referring to FIG. 3, if, at operation 315, the user selects no erasure of data from among the restoration criteria then, at operation 320, the factory settings are restored without deletion of user data. By contrast, if, at operation 315, the user does select to erase data, then the data is erased as per the user selected criteria.

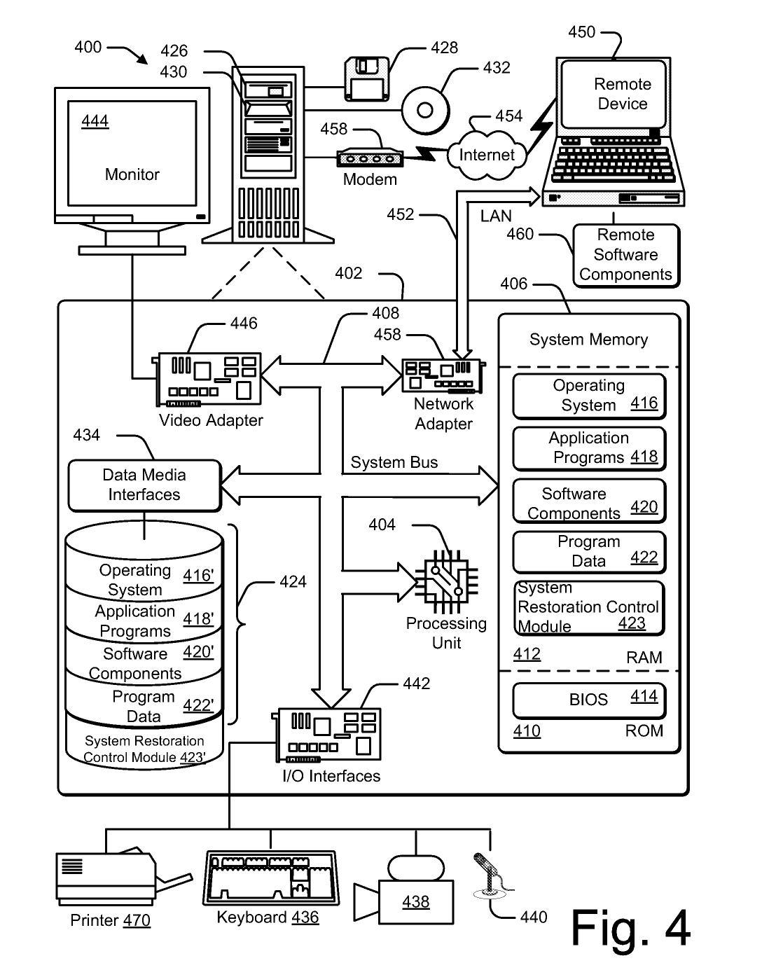

FIG. 4 is a schematic illustration of one embodiment of a computing environment. The components shown in FIG. 4 are only examples, and are not intended to suggest any limitation as to the scope of the functionality of the invention; the invention is not necessarily dependent on the features shown in FIG. 4.

Generally, various different general purpose or special purpose computing system configurations can be used. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The functionality of the computers is embodied in many cases by computer-executable instructions, such as program modules, that are executed by the computers. Generally, program modules include routines, programs, objects, components, data structures, etc. that perform particular tasks or implement particular abstract data types. Tasks might also be performed by remote processing devices that are linked through a communications network. In a distributed computing environment, program modules may be located in both local and remote computer storage media.

The instructions and/or program modules are stored at different times in the various computer-readable media that are either part of the computer or that can be read by the computer. Programs are typically distributed, for example, on floppy disks, CD-ROMs, DVD, or some form of communication media such as a modulated signal. From there, they are installed or loaded into the secondary memory of a computer. At execution, they are loaded at least partially into the computer's primary electronic memory. The invention described herein includes these and other various types of computer-readable media when such media contain instructions, programs, and/or modules for implementing the steps described below in conjunction with a microprocessor or other data processors. The invention also includes the computer itself when programmed according to the methods and techniques described below.

For purposes of illustration, programs and other executable program components such as the operating system are illustrated herein as discrete blocks, although it is recognized that such programs and components reside at various times in different storage components of the computer, and are executed by the data processor(s) of the computer.

With reference to FIG. 4, the components of computer 400 may include, but are not limited to, a processing unit 404, a system memory 406, and a system bus 408 that couples various system components including the system memory 406 to the processing unit 404. The system bus 408 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as the Mezzanine bus, and PCI Express (PCIE).

Computer 400 typically includes a variety of computer-readable media. Computer-readable media can be any available media that can be accessed by computer 400 and includes both volatile and nonvolatile media, removable and non-removable media. By way of example, and not limitation, computer-readable media may comprise computer storage media and communication media. “Computer storage media” includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 400. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network, fiber optic networks, or direct-wired connection and wireless media such as acoustic, RF, infrared and other wireless media. Combinations of any of the above should also be included within the scope of computer readable media.

The system memory 406 includes computer storage media in the form of volatile and/or nonvolatile memory such as read only memory (ROM) 410 and random access memory (RAM) 412. A basic input/output system 414 (BIOS), containing the basic routines that help to transfer information between elements within computer 400, such as during start-up, is typically stored in ROM 410. RAM 412 typically contains data and/or program modules that are immediately accessible to and/or presently being operated on by processing unit 404. By way of example, and not limitation, FIG. 4 illustrates operating system 416, application programs 418, other software components 420, program data 422, and a system restoration control module 423. In some embodiments, the system restoration control module 423 allows the user to restore the computer's settings to the factory defined settings. Although a system restoration returns the computer settings to the factory defaults, this may not be sufficient to protect a user's personally identifiable information from being retrieved. Therefore, in some embodiments, the system restoration control module 423 allows a user to further sanitize the computer memory once a system restoration is complete.

The computer 400 may also include other removable/non-removable, volatile/nonvolatile computer storage media. By way of example only, the computer system of FIG. 4 may include a hard disk drive 424 that reads from or writes to non-removable, nonvolatile magnetic media, a magnetic disk drive 426 that reads from or writes to a removable, nonvolatile magnetic disk 428, and an optical disk drive 430 that reads from or writes to a removable, nonvolatile optical disk 432 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 424 is typically connected to the system bus 408 through a non-removable memory interface such as data media interface 434, and magnetic disk drive 426 and optical disk drive 430 are typically connected to the system bus 408 by a removable memory interface.

The drives and their associated computer storage media discussed above and illustrated in FIG. 4 provide storage of computer-readable instructions, data structures, program modules, and other data for computer 400. In FIG. 4, for example, hard disk drive 424 is illustrated as storing operating system 416′, application programs 418′, software components 420′, program data 422′ and system restoration control module 423′. Note that these components can either be the same as or different from operating system 416, application programs 418, software components 420, and program data 422. Operating system 416, application programs 418, other program modules 420, program data 422 and system restoration control module are given different numbers here to illustrate that, at a minimum, they are different copies. A user may enter commands and information into the computer 400 through input devices such as a keyboard 436 and pointing device 438, commonly referred to as a mouse, trackball, or touch pad. Other input devices (not shown) may include a microphone 440, joystick, game pad, satellite dish, scanner, or the like. These and other input devices are often connected to the processing unit 404 through an input/output (I/Q) interface 442 that is coupled to the system bus, but may be connected by other interface and bus structures, such as a parallel port, game port, or a universal serial bus (USB). A monitor 444 or other type of display device is also connected to the system bus 406 via an interface, such as a video adapter 446. In addition to the monitor 444, computers may also include other peripheral output devices (e.g., speakers) and one or more printers 470, which may be connected through the I/I interface 442.

The computer may operate in a networked environment using logical connections to one or more remote computers, such as a remote computing device 450. The remote computing device 450 may be a personal computer, a server, a router, a network PC, a peer device or other common network node, and typically includes many or all of the elements described above relative to computer 400. The logical connections depicted in FIG. 4 include a local area network (LAN) 452 and a wide area network (WAN) 454. Although the WAN 454 shown in FIG. 4 is the Internet, the WAN 454 may also include other networks. Such networking environments are commonplace in offices, enterprise-wide computer networks, intranets, and the like.

When used in a LAN networking environment, the computer 400 is connected to the LAN 452 through a network interface or adapter 456. When used in a WAN networking environment, the computer 400 typically includes a modem 458 or other means for establishing communications over the Internet 454. The modem 458, which may be internal or external, may be connected to the system bus 406 via the I/I interface 442, or other appropriate mechanism. In a networked environment, program modules depicted relative to the computer 400, or portions thereof, may be stored in the remote computing device 450. By way of example, and not limitation, FIG. 4 illustrates remote application programs 460 as residing on remote computing device 450. It will be appreciated that the network connections shown are exemplary and other means of establishing a communications link between the computers may be used.

Moreover, some embodiments may be provided as computer program products, which may include a machine-readable or computer-readable medium having stored thereon instructions used to program a computer (or other electronic devices) to perform a process discussed herein. The machine-readable medium may include, but is not limited to, floppy diskettes, hard disk, optical disks, CD-ROMs, and magneto-optical disks, ROMs, RAMs, erasable programmable ROMs (EPROMs), electrically EPROMs (EEPROMs), magnetic or optical cards, flash memory, or other suitable types of media or computer-readable media suitable for storing electronic instructions and/or data. Moreover, data discussed herein may be stored in a single database, multiple databases, or otherwise in select forms (such as in a table).

Reference in the specification to “one embodiment” or “an embodiment” means that a particular feature, structure, or characteristic described in connection with the embodiment is included in at least an implementation. The appearances of the phrase “in one embodiment” in various places in the specification are not necessarily all referring to the same embodiment.

1. A computer system, comprising:
at least one processor;
at least one system restoration control module; and
at least one erasure module accessible to a user only through the at least one system restoration module.

2. The computer system of claim 1, wherein the system restoration control module presents a user with one or more system restoration criteria.

3. The computer system of claim 1, wherein the erasure module permits a user to select a portion of the computer system memory is to be erased.

4. The computer system of claim 1, wherein the erasure module permits a user to select a type of memory in the computer system to be erased.

5. The computer system of claim 1, wherein the erasure module permits a user to specify user data in the computer system to be erased.

6. The computer system of claim 2, wherein the erasure module permits a user to select a specified date of creation of data in the computer system before which the data is to be erased.

7. The computer system of claim 2, wherein the erasure module permits a user to select a specified date of creation of data in the computer system after which the data is to be erased.

8. A method, comprising:
detecting an input to start a system restoration control module;
activating the system restoration control module;
presenting, in the system restoration module, an option to start an erasure module; and
starting an erasure module in response to an input requesting an erase option.

9. The method of claim 8, wherein the system restoration control module restores the computer system original factory settings without erasure of user data.

10. The method of claim 8, wherein the erasure module:
detects an input to erase data from the disk; and
erases the data from the disk in the computer system.

11. The method of claim 8, wherein the erasure module:
detects an input as to the portion of the disk to be erased; and
erases the selected portion of the disk.

12. The method of claim 8, wherein the erasure module:
detects an input as to the type of data to be erased; and
erases the selected type of data.

13. The method of claim 8, wherein the erasure module:
detects an input as to a specified user's data to be erased; and
erases the selected user's of data.

14. The method of claim 8, wherein the erasure module:
detects an input as to a date before which data to be erased; and
erases the selected of data.

15. The method of claim 8, wherein the erasure module:
detects an input as to a specified date after which data to be erased; and
erases the selected of data.
